(19) United States
(12) Patent Application Publication
(10) Pub. No.: US 2013/0206441 A1
(43) Pub. Date: Aug. 15, 2013

(54) Minimal Quantity Lubricating System

(71) Applicants: Jochen Roser, Leonberg-Gebersheim (DE); Aldo Di Nicolantonio, Recherswil (CH); Stefano Delfini, Bettlach (CH)

(72) Inventors: Jochen Roser, Leonberg-Gebersheim (DE); Aldo Di Nicolantonio, Recherswil (CH); Stefano Delfini, Bettlach (CH)

(73) Assignee: Robert Bosch GmbH, Stuttgart (DE)

(21) Appl. No.: 13/642,906

(22) PCT Filed: Apr. 11, 2011
(86) PCT No.: PCT/EP2011/055620

§ 371 Date: Mar. 6, 2013

(30) Foreign Application Priority Data
Apr. 27, 2010 (DE) 102010028241.3

(51) Int. Cl. B27C 3/00

(52) U.S. Cl. CPC B27C 3/00
USPC 173/199

(57) ABSTRACT

A minimal quantity lubricating system for a handheld electric power tool is configured to output a lubricating fluid for cooling and/or lubricating a material machining process. The system comprises at least one oscillating unit, an electronic unit for applying at least control and/or feedback signals to the at least one oscillating unit, an operating power unit for providing electric power to the electronic unit, a storage tank for the lubricating fluid, and at least one nozzle associated with the at least one oscillating unit for feeding and atomizing the lubricating fluid in a tool working area. A fluid feed line connects the storage tank to a capillary feed of the lubricating fluid to the oscillating unit, and at least one fluid channel at least partially runs through the oscillating unit to connect the oscillating unit to the nozzle for pulsing the lubricating fluid.

### PRIOR ART

The invention relates to a minimal quantity lubricating system for dispensing a fluid for cooling and/or lubricating a material machining process.

Within the scope of material machining processes, in particular in material removal machining, the tool, for example a drill bit, a cutting blade, an engraving needle, a chisel tip, etc., is often subject to high stress. This stress can lead to heating or destruction of the tool. To increase the service life of the tool, cooling and lubricating additives, in particular cooling lubricating liquids, such as water/oil mixtures, are dispensed at a working region of the tool to cool and lubricate the tool, and result in a decrease in tool temperature and lubrication of the machining site. Such a cooling lubricating agent, which will also be referred to hereinafter as fluid or as lubricating fluid, may be a liquid for cooling material machining processes, such as water or alcohol, or a lubricant such as rapeseed oil. In addition, fluids for integrated cooling and lubrication such as an oil/water emulsion, possibly with further additives such as an anti-corrosion agent, foaming agent or the like, are considered.

In particular in the case of hand-held tools it is advantageous to reduce the quantity of cooling lubricating liquids required, since these tools can only carry a limited supply of lubricants. To reduce the required quantity of cooling lubricants, minimal quantity lubricating systems are known, which can dispense small quantities of the cooling lubricant in aerosol-like form in a working region of the tool, at which the tool machines the workpiece to be machined. This aerosol mixture can be guided to the working region of the tool either externally or through one or more supply ducts in the tool itself (inner supply). In particular in the case of supply within the tool, the cooling lubricant can be dispensed directly at the working region of the tool and thus used efficiently. In this context, minimal quantity lubrication (MQL), which may also provide a cooling effect, describes a cooling and/or lubricating process with a small quantity of fluid, wherein, in the event of cooling, heat produced by the tool and material removal is dissipated. Only small fluid quantities, normally less than 100 ml of cooling lubricant per hour, often less than 20 ml per hour, are normally consumed, whereby MQL thus differs considerably from wet lubrication and wet cooling.

### DISCLOSURE OF THE INVENTION

A minimal quantity lubricating system for a machine tool or a hand-held tool, in particular a hand-held power tool, is proposed and has at least one atomizing unit for dispensing a fluid for cooling and/or lubricating a material machining process. The minimal quantity lubricating system comprises at least one oscillating unit, an electronic unit for applying at least control and/or regulation signals to the at least one oscillating unit, an operating voltage unit for providing an electric power supply to the electronic unit, a storage container for the lubricating fluid, and at least one nozzle, which is assigned to the at least one oscillating unit to supply and to atomize the lubricating fluid in a working region of the tool. A fluid feed line connects the storage container to the oscillating unit for self-priming, in particular capillary, supply of the lubricating fluid, and at least one fluid duct extending through the oscillating unit at least in part connects the oscillating unit to the nozzle to pulse the lubricating fluid. The at least one oscillating unit comprises a volume containing excitable material, which is supplied electrically by the operating voltage unit during operation and is controlled or regulated by the electronic unit such that an atomizing pulse can be applied to the lubricating fluid in the fluid duct.

Due to the ultrasonic atomization, a fine atomization with small droplet diameter can be achieved. Due to the self-priming action of the fluid feed line, it is possible to dispense with a pump. The cooling effect can be switched on and off instantaneously, that is to say without a delay before or after, and has no response time. Due to a variable actuation of the oscillating unit, an accurate and minimal volume metering can be provided. The low consumption of energy during operation and the low requirements for further attachments enables advantageous use of the system in mobile tools, in particular in hand-held power tools. The system can be cleaned in a simple manner due to the large cross section of the ducts. In this case, the oscillating unit may advantageously comprise an ultrasound excitation actuator. The oscillation system of the oscillating unit, which generates a mechanical oscillation frequency, comprises coupled components, in addition to the excitable material, that amplify the ultrasound (boosters) and transfer it to a site of action (sonotrodes). A plurality of oscillating units having the same or different excitation frequency can be operated and are used to generate one or more fluid mists having different droplet sizes.

The minimal quantity lubricating system allows fine atomization with particularly small droplet diameter in the region of 200 μm at most, in particular in the region of 70 μm at most. The droplets are sprayed in a practically silent manner. Ultrasonic atomization can occur independently of an airflow, which may or may not be provided, such that this airflow can be designed specifically for optimal transport of the fluid droplets. The fluid is thus dispensed more uniformly and the fluid mist can be guided in a targeted manner, wherein undesirable splashes of cooling lubricant can be reduced and possibly avoided completely. Since the ultrasonic atomization of the fluid also occurs independently of the media supply, relatively large cross sections of the supply ducts in the region of up to 2 mm, typically up to 1 mm, can be selected to convey the fluid to the atomizer in spite of the small droplet size, thus facilitating cleaning of the ducts. Fluids of relatively high viscosity can therefore also be used.

In accordance with an advantageous development of the invention, the electronic unit can be designed to operate the at least one oscillating unit in a resonance frequency f_res, wherein the electronic unit preferably comprises a regulation unit with frequency adjustment to revise the resonance frequency of the at least one oscillating unit so as to operate the at least one oscillating unit in a resonance frequency whereby the greatest possible performance is achieved and a compact design of the at least one oscillating unit can be enabled. To this end, a sufficiently high quality of the oscillating unit, or of the oscillation system, can be used to provide a high mechanical output with a high level of efficiency and low energy consumption, wherein the quality of the undamped oscillation system can typically reach values of more than 100 to more than 500. If the electronic unit is provided with a regulation unit, which is used for frequency adjustment to revise the resonance frequency of the at least one oscillating unit, the resonance frequency can thus be adjusted continuously, for example if the resonance frequency of the at least one oscillating unit changes due to a different viscosity of the fluid to be dispensed or due to different usage conditions, such as at low or high usage temperatures or load changes. An optimal performance is thus always enabled during operation.

In accordance with an advantageous development of the invention the excitable material of at least one oscillating unit can be piezoelectric or magnetostrictive, wherein the at least one oscillating unit can preferably reach an oscillation amplitude in the range of 2 μm to 200 μm at its free end. The excitable material of at least one oscillating unit may thus be a piezoelectric material, in particular a piezoceramic, such that the piezoelectric material deforms upon application of an electric voltage. Alternatively or also in addition, one or more oscillating units can also be driven by means of a magnetostrictive material. These deform their volume as a result of an applied magnetic field. The driving magnetic field can be output to the magnetostrictive material by means of a magnet coil through which current is made to flow and by means of an iron core. The excitation actuator can thus be formed as a piezoelectric Langevin oscillator or as a magnetostriction oscillator. In particular, it is furthermore advantageous here if the at least one oscillating unit can reach an oscillation amplitude in the range of 2 μm to 200 μm at its free end. A correspondingly high oscillation amplitude is advantageous for efficient droplet generation in the fluid flow and therefore for a fine mist of the fluid.

In accordance with a further advantageous embodiment, the operating frequency of the at least one oscillating unit may lie in the range between 10 kHz and 1000 kHz, preferably between 15 kHz and 60 kHz, more preferably above 20 kHz, in particular between 35 kHz and 45 kHz, and approximately at 40 kHz. Due to an excitation frequency in the ultrasound range, the overall size of the excitation components reduces with increasing frequency, but with increasing mechanical load of the oscillation system, wherein advantageous size ratios with high performance are provided in the selected frequency range alongside advantageous weight of the minimal quantity lubricating system, which facilitates use in the form of a hand-held minimal quantity lubricating system and in the case of integration in a hand-held tool.

A quantity of cooling lubricating fluid to be dispensed can advantageously be set by the electronic unit by means of a timed cycle control. It is thus conceivable for the electronic unit to excite the oscillating unit intermittently, in particular at intervals of 10-5000 ms, preferably 50 to 1200 ms, to regulate a volume of dispensed fluid. Simple timed cycle control of the quantity of fluid dispensed can dispense with mechanical metering means, wherein a highly precise and efficient dispensing of fluid can be enabled by electronic actuation and regulation of the oscillating unit.

In accordance with an advantageous development, an airflow generated by a fan and that can be guided in the nozzle may be used to determine direction and/or to expand the fluid mist. The airflow assists the atomization of the fluid mist and steers it toward the machining site to be cooled and/or to be lubricated, so that low fluid use, high cooling and lubricating effect, and low soiling of external tool and workpiece regions are enabled.

In accordance with a further advantageous development, the nozzle and/or the fluid duct and/or the fluid feed line may comprise at least one cross-sectional tapering to influence a volume of dispensed fluid and preferably to achieve a capillary effect, and/or the fluid duct may extend through the oscillating unit in a manner in which it is angled or bent once or more than once. A cross-sectional tapering regulates the volume flow rate and, as a result of the capillary forces produced by the reduced cross section, can prevent a backflow and also independent discharge of the fluid. It is conceivable to design the cross-sectional tapering so as to be adjustable, in particular electrically or mechanically regulatable, for example by means of an electrically or mechanically acting throttle, valve or the like, so as to make a volume flow rate regulation and/or a capillary effect actively adjustable. An embodiment of the fluid duct in which it is angled or bent once or more than once can ensure an improved transfer of pulse from the oscillating unit to the fluid to be atomized and can also enable a greater flowthrough volume.

In accordance with a further advantageous development, the fluid feed line can be coupled to the oscillating unit in the axial direction of oscillation, or the fluid feed line can be coupled to the oscillating unit substantially at right angles to the axial direction of oscillation in the region of an oscillation node. Axial coupling of the fluid feed line in the axial direction of oscillation makes it possible to easily couple the fluid into the pulsing region of the oscillating unit, in which the fluid duct is subjected to just low mechanical stresses. Furthermore, a lateral, substantially right-angled coupling-in at an oscillation node point is conceivable, at which a possible bearing point of the oscillating unit is arranged, wherein the fluid duct is subject to hardly any mechanical stress.

In accordance with an aspect claimed in a further independent claim, the invention relates to a machine tool or a hand-held tool, in particular a hand-held power tool, which comprises a minimal quantity lubricating system according to the invention, wherein the minimal quantity lubricating system for cooling and/or lubricating a working region of the tool is comprised in a housing of the machine tool or of the tool. It is thus proposed to integrate a minimal quantity lubricating system according to the invention in a tool machine that is already known, wherein such a tool machine or a hand-held power tool may be a lathe, mill, jig saw, circular saw, sabre saw, angle grinder, frame-mounted or hand-held drill, percussion drill, hammer drill, diamond drill or engraving tool for example, or a comparable material removing or material machining machine tool system.

In accordance with an advantageous development of the machine tool or hand-held power tool according to the invention, the machine tool or the power tool may comprise at least one oscillating unit for generating at least one working motion of the tool, wherein the oscillating unit is simultaneously designed to operate the minimal quantity lubricating system. To this end, the presence of an ultrasonic oscillating unit, which is already provided in the machine tool or in the hand-held power tool to provide at least one working motion, is advantageously used to generate an atomizing pulse of the fluid. One or more fluid ducts, which are suitable for atomizing the fluid, may be arranged or suitably fastened in the tool sonotrode with a mounted or coupled tool. For example, such a minimal quantity lubricating system can be integrated in an ultrasound-driven machine tool or in an ultrasound-driven and hand-held power tool, such as an ultrasonic meter, ultrasonic drill, ultrasonic tile-cutting system, ultrasonic polishing system, ultrasonic grinding system or the like.

In accordance with a further advantageous development, the machine tool or the power tool may comprise a rotatable tool, and at least the oscillating unit with the nozzle may be arranged on or in the tool in a co-rotatable manner, wherein the fluid feed line preferably connects the oscillating unit to a storage container located outside the tool region via a rotatable media coupling so as to provide an inner fluid supply. In this case, the rotating tool motion may be generated conventionally by means of an electric motor for example. A rotatable media coupling can guide fluid in a storage container from a stationary tool region into an inner duct of a rotating tool, for example a mill or a drill. A pulse may be applied in the stationary region by means of a high-performance ultrasonic oscillating unit, wherein the oscillating unit may also be arranged in the rotating region.

In accordance with a further aspect claimed in a further independent claim, the invention relates to a retrofit system for a machine tool, said retrofit system comprising a minimal quantity lubricating system according to the invention, wherein the retrofit system can be retrofittably arranged on or fastened to a machine tool to cool and/or lubricate a working region of the tool. A variable minimal quantity lubricating system is thus proposed that can be retrofittably arranged on or fastened to conventional machine tools or hand-held tools. The retrofit system can be electrically activatable in a self-sufficient manner, although it is likewise conceivable to connect the system to the electricity supply of the machine tool or of the hand-held power tool so as to synchronize activation and deactivation with use of the tool.

### DRAWINGS

Further advantages will emerge from the following description of the drawing. The drawing illustrates an exemplary embodiment of the invention. The drawings, the description and the claims contain numerous features in combination. A person skilled in the art will also consider the features individually as appropriate and combine then to form further expedient combinations.

In the drawings:

FIG. 1 shows a schematic illustration of a minimal quantity metering system according to the prior art;

FIG. 2 shows a basic schematic illustration of a second and third minimal quantity lubricating system according to the prior art for outer and inner lubrication and cooling;

FIG. 3 shows a schematic longitudinal sectional illustration of a first exemplary embodiment of a hand-held power tool with a minimal quantity lubricating system;

FIG. 4 shows a schematic longitudinal sectional illustration of a second exemplary embodiment of a hand-held power tool with a minimal quantity lubricating system;

FIG. 5 shows a schematic detailed illustration of a nozzle of the exemplary embodiment in FIG. 4;

FIG. 6 shows a schematic block illustration of an exemplary control circuit of a minimal quantity lubricating system;

FIG. 7 shows a schematic illustration of an exemplary embodiment of an external minimal quantity lubricating system for lubricating and cooling a saw blade;

FIG. 8 shows a schematic basic illustration of two further exemplary embodiments of an internal minimal quantity lubricating system for a hand-held power tool with oscillating unit;

FIG. 9 shows a schematic perspective illustration of a hand-held power tool with minimal quantity lubricating system; and

FIG. 10 shows a schematic illustration of a stationary machine tool with a retrofit exemplary embodiment of a minimal quantity lubricating system.

### EMBODIMENT OF THE INVENTION

Like or similar components are denoted by like reference signs in the figures.

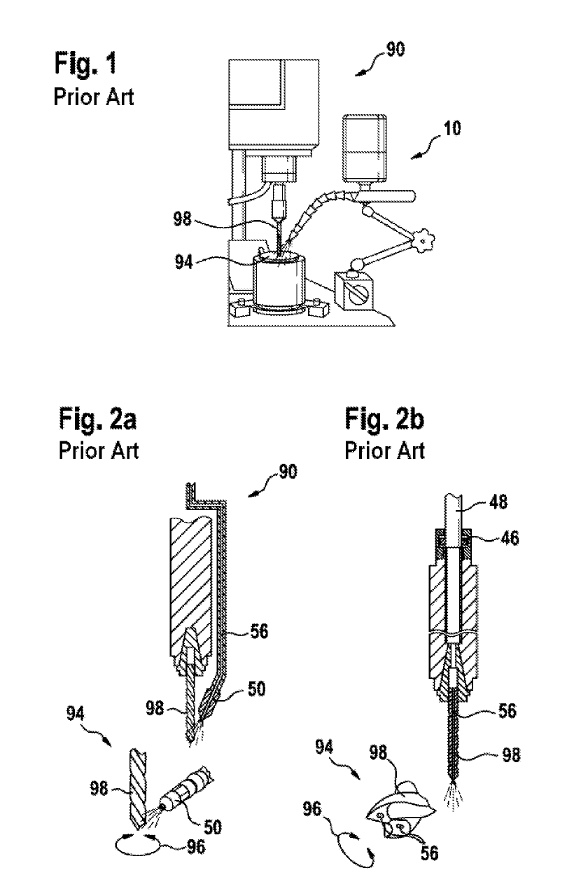

FIGS. 1 and 2 illustrate minimal quantity lubricating systems known from the prior art for cooling and/or lubricating a drilling tool 98 of a bench drill 90. A self-sufficient minimal quantity lubricating system 10 is illustrated in FIG. 1 and dispenses a cooling fluid at the drilling site of the working region 94 of a bench drill 90. The lubricating system 10 can be provided in a versatile manner on different machine tools 90 to cool and/or lubricate. Atomization occurs by means of compressed air, which is generated by an external compressor and is coupled into the atomizer nozzle. FIGS. 2a and 2b show basic illustrations of outer and inner minimal quantity lubrication respectively. Whereas the fluid is atomized in FIG. 2a at the working region 94 of the tool through an external nozzle 50, wherein the fluid 30 is supplied by means of a fluid duct 56, in FIG. 2b the lubricating fluid is supplied through a hollow spindle within the drilling tool 98, wherein the fluid 30 is transferred from a stationary tool region into the rotating drill region through a fluid feed line 48 by means of a media coupling 46 and can exit directly at the drilling site.

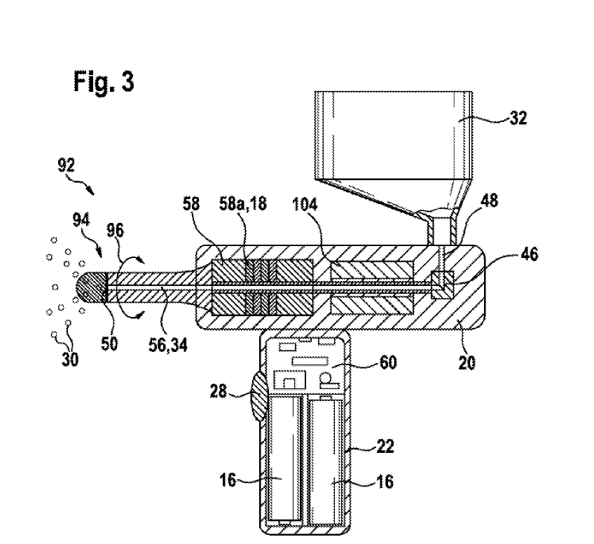

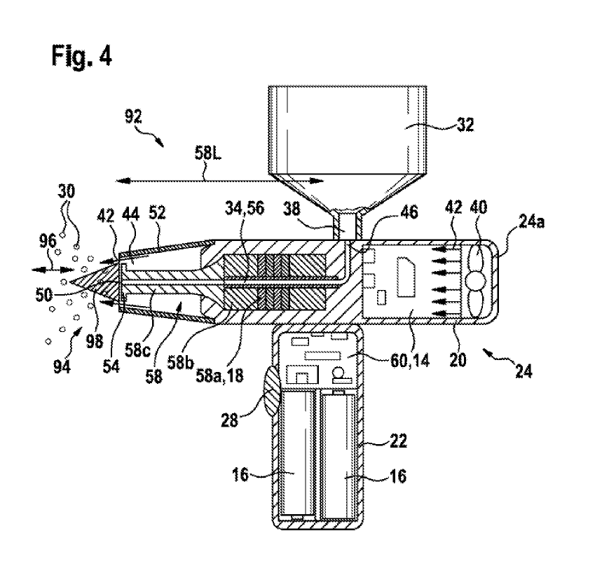

FIG. 3 illustrates a first exemplary embodiment of a hand-held power tool 92 with integrated minimal quantity lubricating system, wherein the power tool 92 is driven conventionally by means of an electric motor 104. The power tool 92 may be an ultrasonic drill system. The heat at the tip of the drilling tool 98 produced during the machining process is dissipated by the atomization of a lubricating fluid 30 from a storage container 32. In this case, the tip 98 of the tool rotates in the direction 96 of a working motion of the tool, as illustrated by an arrow. The storage container 32 is integrated in the power tool 92 and guides the lubricating fluid 30 via a fluid feed line from a stationary tool region, through a media coupling 46 and into an inner fluid duct 34, 56 of the tool 98. The working motion 96 of the tool is generated by means of an electric motor 104, wherein, in the longitudinal working direction 98, high-frequency longitudinal motions are generated in an axial direction of oscillation 100 by an oscillating unit 58 so as to enable fluid atomization and possibly to achieve a “hammer drill effect”. The lubricating fluid 30 exits through a nozzle 50 at the tool head 98 and lubricates and cools the working region 94. The other components of the first exemplary embodiment illustrated in FIG. 3 are explained in greater detail in conjunction with the exemplary embodiment illustrated in FIG. 4, but with the difference that the tool 92 does not comprise a booster 58b nor a sonotrode 58c, but merely an oscillating unit 58 with converter 58a, which consists of excitable piezo discs, which are mounted between two metal parts.

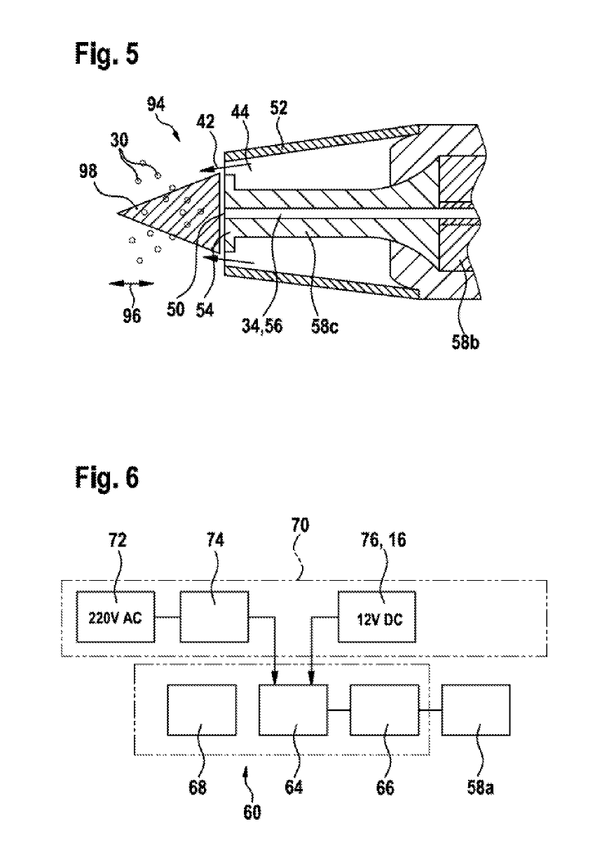

FIGS. 4 and 5 show a second embodiment of a hand-held power tool 92 with integrated oscillating unit 58 for generating a working motion. The oscillating unit 58 simultaneously forms part of the minimal quantity lubricating system 10, which dispenses a fine mist of a fluid 30 from a nozzle 50 to cool or lubricate a working region 94. FIG. 4 shows an overview of the power tool 92 from the side, and FIG. 5 illustrates a detail of the nozzle 50. For example, the power tool 92 is formed as an engraving tool, with which workpiece surfaces can be scratched. The power tool 92 has a housing 20, which has a grip part 22 and a machine part 24. The grip part 22 can be held comfortably in the hand by a user, wherein said grip part is arranged such that a center of gravity of the power tool 92 lies in the region of the grip part. An oscillating unit 58 and an electronic unit 60 for applying at least control and/or regulation signals to the oscillating unit 58 are arranged in the machine part 24.

The power tool 92 further comprises an operating voltage unit 70 arranged within the housing 20, for example a battery pack 16 for mains-independent supply of the electronic units 14 and 60. The battery voltage and electronic unit 60 is connected to the oscillating unit 58, in which a converter region with excitable material 18, for example piezoelectric or magnetostrictive material, is arranged. If electrical signals are applied to the excitable material 18 of the oscillating unit 58, a high-frequency mechanical oscillation is excited in the excitable material 18 and is transferred to a free end 54 of the oscillating unit 58 in the nozzle 50 so that, in addition to the working oscillation of the tool sonotrode 98, a cooling and lubricating fluid 30 supplied in the supply duct 34 of the oscillating unit 58 is split up in the nozzle 50 into the finest of droplets. An interface 38 for a storage container 32 for the fluid 30 is provided on the machine housing 24a, for example a quick coupling on which the storage container 32, for example a storage container, can be fitted. Self-sufficient operation with the power tool 92 is thus possible. The storage container 32 can also be connected fixedly to the power tool 92, as in FIG. 3. A connection for a stationary storage container 32 may optionally also be provided, for example a hose coupling.

The oscillating unit 58 shown comprises a system formed of a sonotrode 58c, booster 58b and converter 58a for adjusting and transferring the high-frequency mechanical oscillation. Alternatively, the oscillating unit 58 may consist just of a single converter. Depending on the user requirements, the minimal quantity lubricating system 10 can be switched on and off together with the tool sonotrode 50 by means of an operating part 28. The operating part 28 may be designed for the electrical connection and disconnection of the electronic unit and also for the release of the fluid 30 into the nozzle 50, for example by means of two switches, for example an on/off switch and a release switch, which are operated in combination. In addition, the arrangement of a temperature sensor in the tool head is conceivable, said temperature sensor being able to activate the minimal quantity lubricating system for cooling when a specific temperature is exceeded. The electronic unit may advantageously be designed to operate the at least one oscillating unit 58 in a resonance frequency f_res, wherein the electronic unit 60 preferably comprises a regulation unit 68 with frequency adjustment to revise the resonance frequency f_res of the at least one oscillating unit 58.

At its free end 54, the oscillating unit 58 may reach an oscillation amplitude in the region of 2 μm to 200 μm. The free end 54 protrudes into air supply ducts 44 in the nozzle 50, where it atomizes the fluid 30 into the finest of droplets. The fluid can be supplied by means of gravity from the storage container 32 into a feed duct 34 comprised by the fluid feed line 48 and through the oscillating unit 58 from behind, or alternatively through a duct 36 from the side, so as to be guided to the nozzle 50 inside the fee oscillator end 54. The fluid 30 can be conveyed away from the nozzle 50 by an airflow 42, 44, which is generated by a fan 40. The fan 40 may be arranged for example on a side of the machine housing 24a opposite the nozzle 50. The airflow 42, 44 can be used to determine direction and/or to expand the fluid mist. A self-priming effect caused by the earth's gravitational pull or by a capillary effect of the fluid feed line 48 is utilized to transport the fluid 30 to the nozzle 50. The operating frequency of the oscillating unit 58 lies in the range between 10 kHz and 1000 kHz for example, preferably between 15 kHz and 60 kHz, preferably above 20 kHz, and in particular at approximately 40 kHz. This enables an advantageously compact design of the power tool 92, since the longitudinal extension 58L of the oscillating unit 58 can be adjusted to the wavelength λ of the excitation frequency of the excitable material 18.

FIG. 6 shows a schematic diagram of the linking of the individual operating units of an ultrasonically excited minimal quantity lubricating system 10, which may be integrated in or additionally fitted on a machine tool 90 or a tool, in particular a power tool 92. Viewed schematically, the ultrasonically excited minimal quantity lubricating system 10 comprises an operating voltage unit 70, which provides an electrical operating voltage for operation of the minimal quantity lubricating system 10. The operating voltage unit 70 comprises a mains voltage module 72, 74, which can generate a suitable d.c. voltage, for example 24 or 12 volts, from a voltage from the public mains voltage, for example a 240 volt a.c. voltage, wherein the operating voltage unit 70 can be used both to supply the minimal quantity lubricating system 10 and to supply voltage to the hand-held or stationary tool 90, 92. In another embodiment the operating voltage unit 70 comprises a battery voltage module 76 instead of the components 72, 74, said battery voltage module providing the voltage supply by means of a battery pack or a battery. An electronic unit 60, in which a regulation unit 68 is located, is connected to the operating voltage unit 70. The regulation unit 68 generates electrical regulation and/or control signals for operating the oscillating unit 58. To this end, the regulation unit 68 may have a feedback function so as to revise a resonance frequency of the mechanical drive system of the oscillating unit 58 under changing resonance conditions and so as to provide a frequency-adjusted voltage supply for operation of the oscillating unit 58. The regulation unit 68 is connected to a power stage 64 and a corresponding adaptation network 66.

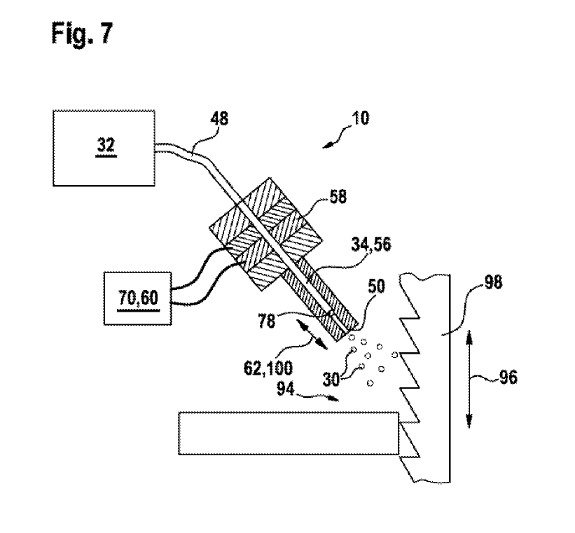

FIG. 7 shows a basic illustration of a detailed region of a jig saw 92 with a saw blade 98 for sawing a workpiece. The saw blade 98 moves up and down in a direction 96 of working motion of the tool illustrated by a double-headed arrow. A cooling and lubricating fluid 30 is introduced in the working region 94 of the tool by means of a nozzle 50 of a minimal quantity lubricating system 10. The minimal quantity lubricating system 10 is connected via a fluid feed line 48 to an external storage container 32. The oscillating unit 58 comprises a converter and is oscillated by means of an operating voltage unit 70 and an electronic unit 60. The lubricating fluid 30 flows through the oscillating unit 58 by means of a supply duct 34, wherein a cross-sectional tapering 78 is arranged at the nozzle 50 so as to achieve a capillary effect. The atomized mist of the fluid 30 exits at the nozzle opening 50 and cools the saw region.

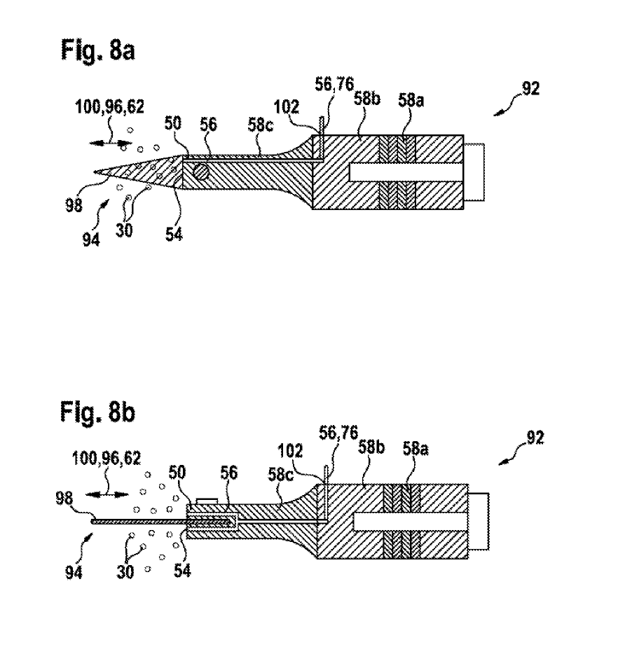

FIG. 8 illustrates the basic principles of two variants of an internal minimal quantity lubricating system 10, which is integrated in a power tool 92 operated by ultrasound. The tool 98 is cooled by the atomized fluid 30, which is dispensed in the form of a mist via one or more nozzles 50 at the tool head. An oscillating unit 58 for generating the working motion 96 of the tool in the axial direction of oscillation 100 is already integrated in the power tool 92. The illustrated oscillating unit 58 comprises a converter 58a, a booster 58b and a sonotrode 58c, but may also consist of just a converter. This oscillating unit 58 is advantageously used to generate an atomizing pulse 62 by guiding a fluid 30 through a lateral fluid supply duct 36, which is arranged at an oscillation node 102 of the oscillating unit 58, and by guiding said fluid through the oscillating unit 58. The fluid 30 absorbs the atomizing pulse 62 along the fluid duct 56 and is atomized at the end face of the sonotrode 58c through the nozzle 50. FIG. 8a illustrates a jointing chisel 92, wherein a chisel-shaped tool 98 is displaced in linearly oscillating oscillations 96 by the oscillating unit 58, which simultaneously exert the atomizing pulse 62 to atomize the fluid 30. FIG. 8b shows an engraving needle 98, wherein this is cooled by a plurality of nozzles 50, which are formed by a multiple bending and spreading of the fluid duct 56, whereby the atomizing pulse 62 is better absorbed and can be dispensed in a more finely distributed manner. To this end, a plurality of nozzle openings 50 are arranged in the end face of the oscillator 58. Alternatively, the supply duct 36 may not be provided laterally, but instead axially from behind.

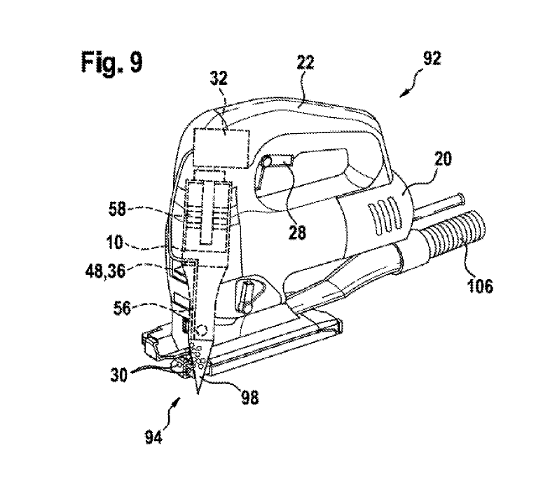

FIG. 9 shows a perspective illustration of an ultrasonic tool 92 with integrated minimal quantity lubricating system, as is illustrated by way of the basic principles in FIG. 8. The ultrasound-driven power tool 92 is used to cut hard materials, such as tiles or glass, wherein a high level of frictional heat is produced by the process. To increase the service life, improve the machining quality and reduce operating costs, cooling of the working region 94 of the tool by means of a minimal quantity lubricating system 10 is provided. The fluid 30 is housed in a storage container 32 in the upper housing region of the hand-held power tool machine 92 and can be replenished. The working oscillating unit 58 likewise generates the atomizing pulse 62 necessary for atomization, wherein the fluid 30 is introduced laterally into the oscillating unit 56 through a fluid feed line 36, 48 and is dispensed at the tool head 98 via a nozzle 50.

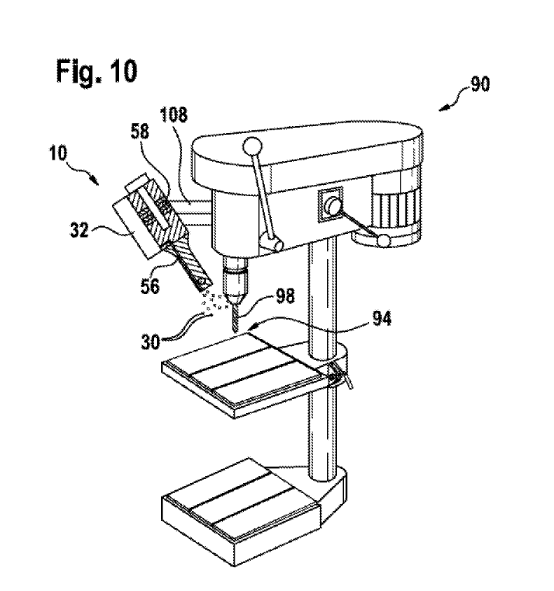

The minimal quantity lubricating system 10 may advantageously be formed self-sufficiently and therefore may be arranged in a versatile manner in working regions of different tools or machine tools 90. For example, it can be arranged as a retrofit system on a machine tool 90. FIG. 10 thus shows a bench drill 90, on which a minimal quantity lubricating system 10 is arranged, which can dispense fluid 30 at the drill head to cool and lubricate the drilling process. The retrofit system comprises a replenishable storage container 32 and an oscillating unit 58, which is battery operated or mains operated and applies an atomizing pulse 62 to the fluid 30 within the fluid duct 56. The retrofit system can be fastened to the machine tool 90 by means of a suitable and adjustable lubricating system fastening 108, such that the atomizing mist of fluid 30 is dispensed accurately at the tip of the drilling tool 98.

On the one hand, technology for cooling and lubricating a material machining process in a cleaner, more reliable and completely silent manner by use of a cooling and/or lubricating fluid 30 is provided by means of the invention, and on the other hand an energy-saving and compact minimal quantity lubricating system 10 with an innovative drive concept is proposed.

1. A minimal quantity lubricating system for a hand-held power tool, configured to dispense a lubricating fluid for cooling and/or lubricating a material machining process, comprising:
at least one oscillating unit;
an electronic unit configured to apply at least control and/or regulation signals to the at least one oscillating unit;
an operating voltage unit configured to provide an electric power supply to the electronic unit;
a storage container for the lubricating fluid;
at least one nozzle, which is assigned to the at least one oscillating unit and is configured to supply and to atomize the lubricating fluid in a working region of the tool;
a fluid feed line configured to connect the storage container to the oscillating unit for capillary supply of the lubricating fluid; and
at least one fluid duct extending through the oscillating unit at least in part connecting the oscillating unit to the nozzle to pulse the lubricating fluid, and
wherein the at least one oscillating unit comprises a volume containing excitable material, which is supplied electrically by the operating voltage unit during operation and is controlled or regulated by the electronic unit such that an atomizing pulse can be applied to the lubricating fluid in the fluid duct.

2. The minimal quantity lubricating system as claimed in claim 1, wherein:
the electronic unit is configured to operate the at least one oscillating unit in a resonance frequency, and
the electronic unit comprises a regulation unit with frequency adjustment to revise the resonance frequency of the at least one oscillating unit.

3. The minimal quantity lubricating system as claimed in claim 1, wherein:
the excitable material is piezoelectric or magnetostrictive, and
the at least one oscillating unit reaches an oscillation amplitude in the range of 2 μm to 200 μm at its free end.

4. The minimal quantity lubricating system as claimed in claim 1, wherein:
the operating frequency of the at least one oscillating unit lies in the range between 15 kHz and 60 kHz, and/or
the electronic unit is configured to excite the oscillating unit intermittently, at intervals 50 to 1200 ms, to regulate a volume of dispensed fluid.

5. The minimal quantity lubricating system as claimed in claim 1, wherein an airflow generatable by a fan is used to determine direction and/or to expand the fluid mist.

6. The minimal quantity lubricating system as claimed in claim 1, wherein:
the nozzle and/or the fluid duct and/or the fluid feed line comprises at least one cross-sectional tapering to influence a volume of dispensed fluid and to achieve a capillary effect, and/or
the fluid duct extends through the oscillating unit in a manner in which it is angled or bent once or more than once.

7. The minimal quantity lubricating system as claimed in claim 1, wherein:
the fluid feed line is coupled to the oscillating unit in the axial direction of oscillation, or
the fluid feed line is coupled to the oscillating unit substantially at right angles to the axial direction of oscillation in the region of an oscillation node.

8. A hand-held power tool, comprising:
a housing; and
a minimal quantity lubricating system, including (i) at least one oscillating unit, (ii) an electronic unit configured to apply at least control and/or regulation signals to the at least one oscillating unit, (iii) an operating voltage unit configured to provide an electric power supply to the electronic unit, (iv) a storage container for the lubricating fluid, (v) at least one nozzle assigned to the at least one oscillating unit and configured to supply and to atomize the lubricating fluid in a working region of the power tool, (vi) a fluid feed line configured to connect the storage container to the oscillating unit for capillary supply of the lubricating fluid, and (vii) at least one fluid duct extending through the oscillating unit at least in part connecting the oscillating unit to the nozzle to pulse the lubricating fluid,
wherein the at least one oscillating unit comprises a volume containing excitable material, which is supplied electrically by the operating voltage unit during operation and is controlled or regulated by the electronic unit such that an atomizing pulse can be applied to the lubricating fluid in the fluid duct, and
wherein the minimal quantity lubricating system for cooling and/or lubricating a working region of the tool is comprised in the housing of the power tool.

9. The power tool as claimed in claim 8, further comprising:
at least one oscillating unit configured to generate at least one working motion of the tool,
wherein the oscillating unit is simultaneously designed to operate the minimal quantity lubricating system.

10. The power tool as claimed in claim 8, further comprising:
a rotatable tool, and at least the oscillating unit with the nozzle is arranged on or in the tool in a co-rotatable manner,
wherein the fluid feed line is configured to connect the oscillating unit to a storage container located outside the tool region via a rotatable media coupling.

11. A retrofit system for a machine tool, comprising:
a minimal quantity lubricating system, including (i) at least one oscillating unit, (ii) an electronic unit configured to apply at least control and/or regulation signals to the at least one oscillating unit, (iii) an operating voltage unit configured to provide an electric power supply to the electronic unit, (iv) a storage container for the lubricating fluid, (v) at least one nozzle assigned to the at least one oscillating unit and configured to supply and to atomize the lubricating fluid in a working region of the power tool, (vi) a fluid feed line configured to connect the storage container to the oscillating unit for self-priming supply of the lubricating fluid, and (vii) at least one fluid duct extending through the oscillating unit at least in part connecting the oscillating unit to the nozzle to pulse the lubricating fluid,
wherein the at least one oscillating unit comprises a volume containing excitable material, which is supplied electrically by the operating voltage unit during operation and is controlled or regulated by the electronic unit such that an atomizing pulse can be applied to the lubricating fluid in the fluid duct, and
wherein the retrofit system can be retrofittably arranged on or fastened to a machine tool to cool and/or lubricate a working region of the tool.
